(19) United States
(12) Patent Application Publication
(10) Pub. No.: US 2006/0080036 A1
(43) Pub. Date: Apr. 13, 2006

(54) Method for determining vehicle location

(75) Inventor: Jeffrey M. Stefan, Clawson, MI (US)

Correspondence Address: General Motors Corporation;Mail Code 482-C23-B21, 300 Renaissance Center, P.O. Box 300, Detroit, MI, 48265-3000, US

(73) Assignee: General Motors Corporation

(21) Appl. No.: 10/960,525

(22) Filed: Oct. 7, 2004

(51) Int. Cl. G06F 15/00

(52) U.S. Cl. 701/300; 702/150

(57) ABSTRACT

A method for determining a vehicle location includes receiving location inputs from at least one location indicator. The method includes determining a quality indicator for each location input and determining the vehicle location based on the quality indicator determination.

### FIELD OF THE INVENTION

This invention relates generally to methods of locating vehicles. In particular, the invention relates to locating vehicles using sensors.

### BACKGROUND OF THE INVENTION

GPS devices and other sensors, provide an opportunity to monitor the location of vehicles. Other sensors that provide location information include wheel speed sensors, odometers, magnometers, gyroscopes, turn rate sensors, and the like. However, sensor information is subject to degradation or conflict with other sensors. For example, buildings or other natural features can interfere with GPS signals.

It is therefore desirable to provide a method for locating vehicles that overcomes the limitations, challenges, and obstacles described above.

### SUMMARY OF THE INVENTION

One aspect of the present invention provides a method for locating a vehicle. The method includes receiving location inputs from at least one location indicators and determining a quality indicator for each location input. The method further includes selecting at least one location indicators responsive to the determined quality indicators. The method further includes determining the vehicle location based on the selected plurality of location indicators.

Another aspect of the present invention provides a computer readable medium storing a computer program for locating a vehicle. The medium includes computer readable code for receiving location inputs from at least one location indicators and computer readable code for determining a quality indicator for each location input. The medium further includes computer readable code for selecting at least one location indicators responsive to the determined quality indicators. The medium further includes computer readable code for determining the vehicle location based on the selected plurality of location indicators.

A third aspect of the present invention provides a system for assisting in locating a vehicle. The system includes means for receiving location inputs from at least one location indicators and means for determining a quality indicator for each location input. The system further includes means for selecting at least one location indicators responsive to the determined quality indicators. The system further includes means for determining the vehicle location based on the selected plurality of location indicators.

The aforementioned and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1A is a schematic diagram of one embodiment of a system for locating vehicles in accordance with the present invention;

FIG. 1B is a schematic diagram of a vehicle location;

FIG. 1C is a schematic diagram of a vehicle location;

FIG. 2 is a flowchart representative of one embodiment of a method for locating vehicles in accordance with the present invention;

FIG. 3 is a flowchart representative of one embodiment of a method for locating vehicles in accordance with the present invention;

FIG. 4 is a flowchart representative of one embodiment of a method for locating vehicles in accordance with the present invention; and

FIG. 5 is a schematic diagram of one embodiment of a system for locating vehicles in accordance with the present invention.

### DETAILED DESCRIPTION OF THE PRESENTLY PREFERRED EMBODIMENTS

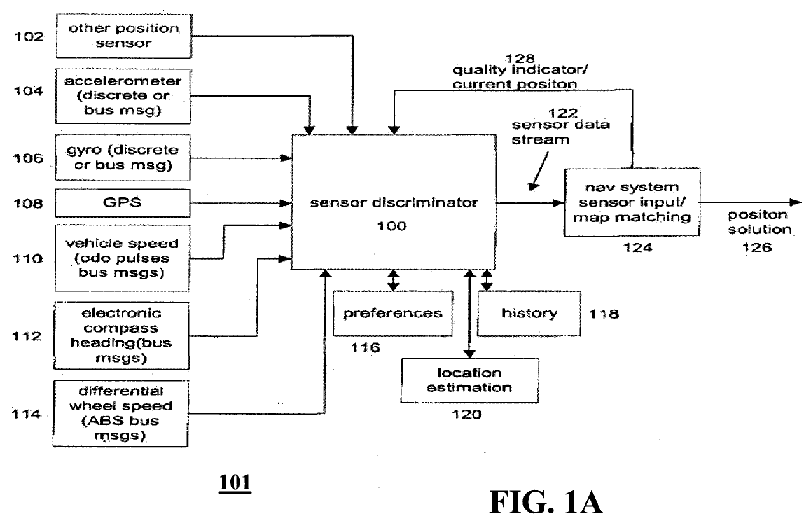

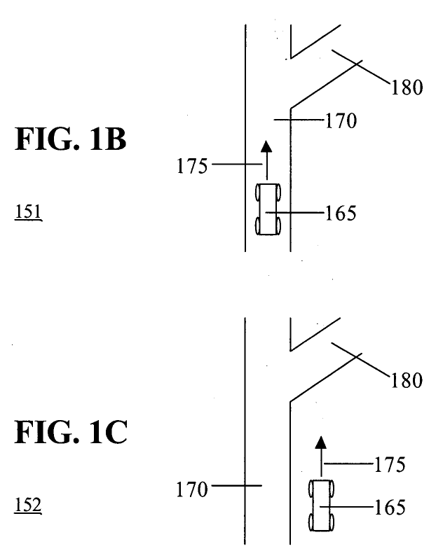

FIG. 1A illustrates one embodiment of a system for locating vehicles in accordance with the present invention at 101. System 101 includes sensor discriminator 100. Sensor discriminator 100 communicates with position sensor 102, accelerometer 104, gyroscope 106, GPS unit 108, vehicle speed sensor 110, electronic compass 112 and differential wheel speed sensor 114. Additionally, sensor discriminator 100 is in communication with user preferences 116, location estimation 120, history 118 and a navigation system 124.

Sensor discriminator 100 includes a processor connected to the sensors described above. In one embodiment, sensor discriminator 100 is a component of a telematics unit (not shown) configured to engage in wireless communications with a call center. In one embodiment, the processor is implemented as a micro-controller, microprocessor, controller, host processor, or vehicle communications processor. In an example, the processor is implemented as an application-specific integrated circuit (ASIC). In another embodiment, the processor is implemented as a processor working in conjunction with a central processing unit (CPU) performing the function of a general-purpose processor.

Communications between sensor discriminator 100 and the sensors 102-114 occur using a vehicle communication network. In facilitating interactions among the various communication and electronic modules, vehicle communication network utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

Position sensor 102 is any sensor that provides a signal capable of indicating a current location of a vehicle. Position sensor 102 can be of the same or a different type than one of accelerometer 104, gyroscope 106, GPS unit 108, vehicle speed sensor 110, electronic compass 112 and differential wheel speed sensor 114. The position sensor 102 may be a hybrid sensor, such as, for example, a gyroscopic compass.

Accelerometer 104 provides a signal responsive to the rate of acceleration currently being experienced by the vehicle. In one embodiment, accelerometer 104 is a vehicle module connected to vehicle bus and sending acceleration signals to the sensor discriminator 100. In one embodiment, accelerometer 104 provides discrete signals to sensor discriminator 100.

Gyroscope 106 is a sensor providing gyroscopic signals responsive to angular vehicle movement. In one embodiment, gyroscope 106 is a vehicle module connected to vehicle bus and sending angular motion signals to the sensor discriminator 100. In one embodiment, gyroscope 106 provides discrete signals to sensor discriminator 100.

GPS unit 108 provides longitude and latitude coordinates of the vehicle responsive to a GPS broadcast signal received from one or more GPS satellite broadcast systems (not shown). GPS unit 108 also provides a time stamp in one embodiment. In another embodiment, GPS unit 108 provides a Dilution of Precision (“DOP”) signal. A DOP signal indicates the quality of a GPS broadcast signal received by GPS unit 108. In another embodiment, GPS unit 108 provides vehicle speed over ground information, course over ground, and magnetic variation.

Vehicle speed sensor 110 is a sensor providing speed signals responsive to vehicle movement. In one embodiment, vehicle speed sensor 110 is a vehicle module connected to the vehicle bus and sending speed signals to the sensor discriminator 100. Vehicle speed sensor 110 provides discrete signals to sensor discriminator 100 in one embodiment. In one embodiment, vehicle speed sensor 110 obtains odometer pulses using the vehicle bus. Odometer pulse data is comprised of electronic pulses generated from sensors within the vehicle that are calibrated for a number of transitions from a logical one to a logical zero per unit distance, such as, for example, one mile or one kilometer. For example, if the odometer provides 5280 pulses per mile, this resolves to one pulse per foot. In one embodiment, odometer pulses are generated by counting the number of revolutions of a flywheel or other rotational component in a vehicle when the vehicle drivetrain is fully engaged and the vehicle is in forward motion. The counted number of revolutions are calibrated to a unit distance.

Electronic compass 112 is a vehicle module configured to provide a compass reading responsive the direction of travel. Differential wheel speed sensor 114 obtains the speed difference for tires to determine turning information. Those skilled in the art will appreciate that more or fewer sensors than sensors 102-114 can be used in the system 101. All sensors 102-114 need not be used in the system 101.

User preferences 116 contains a list of customizable settings that have default values or have values customized by a user using any appropriate data entry scheme. In one embodiment, user preferences are set using a button push. In another embodiment, user preferences are set using a voice interface with speech recognition capability. In another embodiment, user preferences are set using a controller in communication with a telematics unit. In another embodiment, user preferences are set using a wireless packet data network connection via the Internet. User preferences 116 are stored in volatile or non-volatile memory such as ROM, flash memory or disk-based storage devices. For example, user preferences 116 includes a user preference for recording location alerts in one embodiment. In another example, user preferences 116 includes a user preference for the rate at which the methods described herein iterate. In other embodiments, a vehicle designer or navigation system supplier provides user preferences 116.

History 118 stores location alerts, sensor selection data and other data produced by sensor discriminator 100. In one embodiment, history 118 is stored in volatile or non-volatile memory such as ROM, flash memory or disk-based storage devices. In one embodiment, history 118 is stored in the same unit as user preferences 116. History 118, in one embodiment, contains information relating to the conditions causing a sensor combination change. Information relating to the conditions causing a sensor combination change can be Figure of Merit (FOM) values that have changed, location where the change occurred, time or other parameters affecting the expected accuracy of the sensors. A Figure of Merit is a numerical quantity that describes various performance criteria for instruments, such as, for example, sensors. A location estimation data store is stored in history 118 in one embodiment. The location estimation data store describes or bounds the geographic area within a polygonal area and produces an index value to point to sensor selection data within history 118.

Location estimation 120 stores location information in response to locations estimated by sensor discriminator 100. In one embodiment, location estimation 120 is stored in volatile or non-volatile memory such as ROM, flash memory or disk-based storage devices. In one embodiment, location estimation 120 is stored in the same unit as user preferences 116.

User preferences 116, history 118 and location estimation 120 are in two-way communication with sensor discriminator 100 and able to send and receive signals.

Sensor discriminator 100 sends a sensor data stream 122 to a navigational system sensor input 124 for map matching. Navigational system sensor input 124 compares the information in sensor data stream 122 from sensor discriminator 100 to a pre-existing map to provide a quality indicator signal 128 to sensor discriminator 100. For example, in the event that sensor discriminator 100 indicates that a vehicle has left an interstate highway but is not on another road, the navigational system sensor input 124 shows that the quality of the estimated vehicle location is low, and sends a quality indicator signal 128 to sensor discriminator 100 indicating a low degree of quality or confidence that the estimated location is accurate.

In one embodiment, position solution 126 is sent from the navigational system sensor input 124 when there is a high degree of confidence that the indicated vehicle location is accurate in another embodiment, position solution 126 is sent from the navigational system sensor input 124 and indicates a low degree of confidence when the navigation system sensor input 124 shows a low quality indicator signal 128.

FIG. 1B and FIG. 1C illustrate an example of the map matching process. FIG. 1B illustrates at 151 vehicle 165 traveling in direction 175 on road 170 near its intersection with ramp 180. In FIG. 1B, the indicated vehicle location appears to be accurate, as vehicle 165 is on road 170. Conversely, in FIG. 1C at 152, vehicle 165 appears to be traveling in direction 175, but vehicle 165 is not on the road 170. In one embodiment, navigation system sensor input 124 would assign the vehicle in FIG. 1B a high value for quality indicator signal 128, whereas the navigation system sensor input 124 would assign a low value for quality indicator signal 128 to the vehicle in FIG. 1C. In the embodiment where the quality indicator is assigned a low value, the sensor discriminator 100 examines the preferences 116, history 120, and location estimation for a preferred sensor or set of sensors to use. For example, vehicle speed pulses 110 and an electronic compass 112 may be utilized as location sensor inputs in lieu of GPS 108.

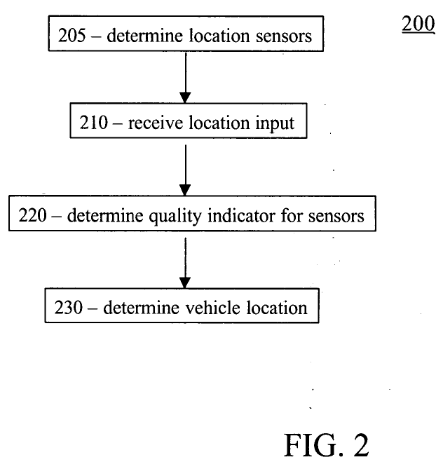

FIG. 2 illustrates a flowchart representative of one embodiment of a method for locating a vehicle. Method 200 begins by determining the location sensors at step 205. Determining the location sensors includes querying a vehicle bus in one embodiment. In another embodiment, determining the location sensors includes receiving a list of sensors input by a user, manufacturer or designer. In another embodiment, determining the location sensors includes receiving a list of sensors through a telematics unit.

After determining the location sensors, a location input from each sensor is received at step 210. In one embodiment, the location inputs are received in a telematics unit. In another embodiment, the location inputs are received by sensor discriminator 100 (FIG. 1).

A quality indicator is determined for each sensor input in step 220. A quality indicator represents an estimation of the accuracy of the sensor input. A quality indicator is based on a DOP signal from a GPS satellite in one embodiment. In another embodiment, a quality indicator is based on a comparison between a map and a vehicle location indicated by a particular sensor. In one embodiment, a quality indicator is based on a comparison of map truth and positional truth. Map truth is defined as a representation of a vehicle's true location plotted on a map or an indicated position and positional truth is defined as a vehicle's true position. Based on the determined quality indicators and location inputs, a vehicle location is determined in step 230.

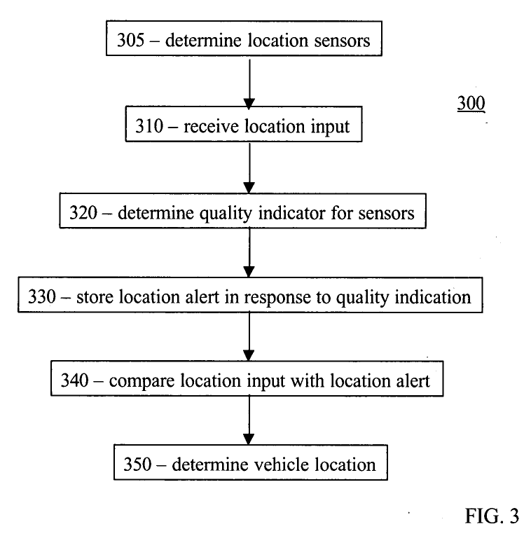

FIG. 3 illustrates a flowchart representative of one embodiment of a method for locating a vehicle. Method 300 begins by determining the location sensors at step 305. In one embodiment, step 305 is implemented as in step 205 of FIG. 2.

After determining the location sensors, a location input from each sensor is received at step 310. In one embodiment, step 310 is implemented as in step 210 of FIG. 2. A quality indicator is determined for each sensor input in step 320. In one embodiment, step 320 is implemented as in step 220 of FIG. 2.

A location alert is stored in response to a failed quality indicator at step 330. A failed quality indicator is defined as a quality indicator with low indicia of reliability. For example, a location alert is generated in response to a low quality indicator. A location alert includes information relating to the circumstances surrounding a low quality indicator. For example, a location alert includes time of day, vehicle location, vehicle speed, vehicle acceleration and differential wheel speed data, or a combination of sensor input data. For example, when traveling into an urban canyon, where GPS signals often become unreliable, and in response to traveling into an urban canyon, a location alert records information surrounding the entry. In one embodiment, location alerts are stored in history 118 (FIG. 1).

The determined location is compared to previously stored location alerts at step 340. If no location alerts are stored for the determined location, the quality of a location input is higher. The determined location indicated by the sensors can be compared to stored location alerts, and if a reasonable position match is made by using a radius or irregular polygon, the group of sensors utilized the previous time the vehicle was at the indicated determined location can be switched in.

For example, using GPS unit 108, odometer pulses 110 and gyroscope 106, a vehicle enters the urban canyon in Detroit, Mich., surrounding the Renaissance Center. The GPS signal received by GPS unit 108 indicates a poor DOP value. In response, the sensor discriminator 100 determines that based on history 118, a high quality indicator was previously achieved by combining the odometer pulses 110, gyroscope 106 and differential wheel speed sensor 114, and switches the GPS unit 108 sensor out of the calculation of vehicle location while switching the differential wheel speed sensor 114 into the calculation.

In another example, using GPS unit 108, odometer pulses 110 and gyroscope 106, a vehicle enters the urban canyon in Chicago, Ill., for the first time when the GPS signal received by GPS unit 108 degrades. As the vehicle has not been to this location before, no history 118 is available. In response, sensor discriminator establishes quality indicators for each sensor and uses the best quality indicators in the determination of the vehicle location.

A vehicle location is determined in response to the comparison, the determined location input and the determined quality indicator at step 350.

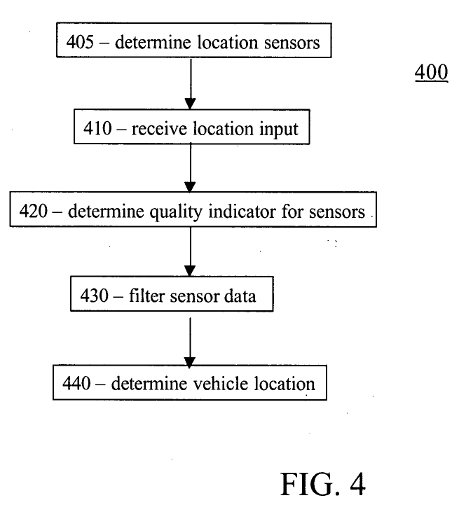

FIG. 4 illustrates a flowchart representative of one embodiment of a method for locating a vehicle. Method 400 begins by determining the location sensors at step 405. Determining the location sensors includes querying a vehicle bus in one embodiment. In another embodiment, determining the location sensors includes receiving a list of sensors input by a user, manufacturer or designer.

After determining the location sensors, a location input from each sensor is received at step 410. In one embodiment, the location inputs are received in a telematics unit. In another embodiment, the location inputs are received by sensor discriminator 100 (FIG. 1).

A quality indicator is determined for each sensor input in step 420. A quality indicator represents an estimation of the accuracy of the sensor input. A quality indicator is based on a DOP signal from a GPS satellite in one embodiment. In another embodiment, a quality indicator is based on a comparison between a map and a vehicle location indicated by a particular sensor.

A filter is applied to the sensor data at step 430. Filtering sensor data removes noise to improve the signal to noise ratio for the quality indicator signal. In one embodiment, the filter is a Kalman filter. A Kalman filter is an optimal recursive data processing algorithm to process incoming sensor data and incorporate each datum, regardless of its precision to generate a best estimate of vehicle location.

Based on the filtered sensor data, a vehicle location is determined in step 440.

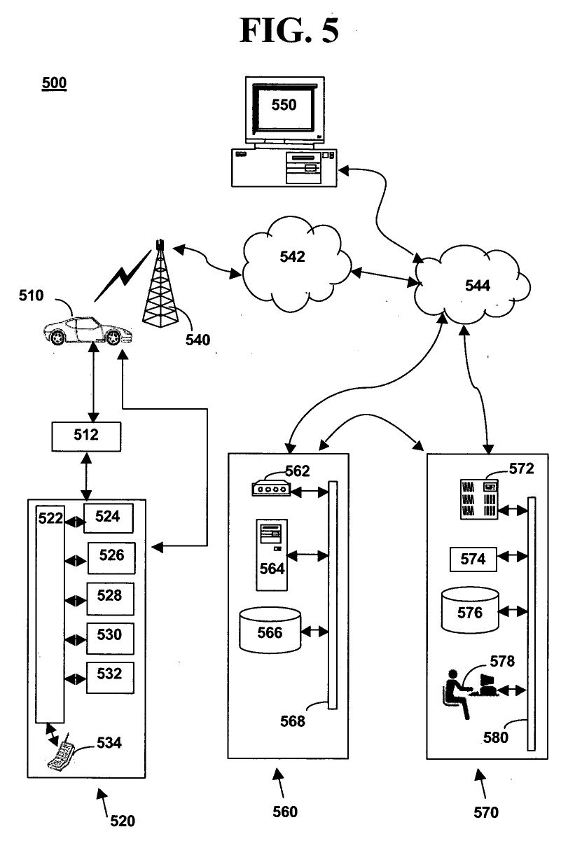

In one embodiment, a call center is in communication with the vehicle using a motor vehicle communication system, as illustrated in FIG. 5 at 500. System 500 includes a mobile vehicle communication unit (MVCU) 510; a vehicle communication network 512; a telematics unit 520; one or more wireless carrier systems 540; one or more communication networks 542; one or more land networks 544; one or more client, personal, or user computers 550; one or more web-hosting portals 560; and one or more call centers 570. In one embodiment, MVCU 510 is implemented as a mobile vehicle equipped with suitable hardware and software for transmitting and receiving voice and data communications. In an example, a display is embedded in MVCU 510. The display is a dialed digital display such as a radio unit or an instrument panel. MVCS 500 may include additional components not relevant to the present discussion.

MVCU 510 is referred to as a mobile vehicle in the discussion below. In operation, MVCU 510 may be implemented as a motor vehicle, a marine vehicle, or as an aircraft. MVCU 510 may include additional components not relevant to the present discussion.

Vehicle communication network 512 sends signals to various units of equipment and systems (detailed below) within MVCU 510 to perform various functions such as unlocking a door, opening the trunk, setting personal comfort settings, and calling from telematics unit 520. In facilitating interactions among the various communication and electronic modules, vehicle communication network 512 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

Telematics unit 520, sends and receives radio transmissions from wireless carrier system 540. Wireless carrier system 540 is implemented as any suitable system for transmitting a signal from MVCU 510 to communication network 542.

Telematics unit 520 includes a processor 522 connected to a wireless modem 524, a global positioning system (GPS) unit 525, an in-vehicle memory 528, a microphone 530, one or more speakers 532, and an embedded or in-vehicle mobile phone 534. In other embodiments, telematics unit 520 may be implemented without one or more of the above listed components such as, for example, speakers 532. Telematics unit 520 may include additional components not relevant to the present discussion.

In one embodiment, processor 522 is implemented as a microcontroller, microprocessor, controller, host processor, or vehicle communications processor. In an example, processor 522 is implemented as an application-specific integrated circuit (ASIC). In another embodiment, processor 522 is implemented as a processor working in conjunction with a central processing unit (CPU) performing the function of a general purpose processor. GPS unit 526 provides longitude and latitude coordinates of the vehicle responsive to a GPS broadcast signal received from one or more GPS satellite broadcast systems (not shown). In-vehicle mobile phone 534 is a cellular-type phone such as, for example, an analog, digital, dual-mode, dual-band, multi-mode or multi-band cellular phone.

Processor 522 executes various computer programs that control programming and operational modes of electronic and mechanical systems within MVCU 510. Processor 522 controls communications (e.g., call signals) between telematics unit 520, wireless carrier system 540, and call center 570. In one embodiment, a voice-recognition application is installed in processor 522 that can translate human voice input through microphone 530 to digital signals. Processor 522 generates and accepts digital signals transmitted between telematics unit 520 and a vehicle communication network 512 that is connected to various electronic modules in the vehicle. In one embodiment, these digital signals activate the programming mode and operation modes, as well as provide for data transfers.

Communication network 542 includes services from one or more mobile telephone switching offices and wireless networks. Communication network 542 connects wireless carrier system 540 to land network 544. Communication network 542 is implemented as any suitable system or collection of systems for connecting wireless carrier system 540 to MVCU 510 and land network 544.

Land network 544 connects communication network 542 to computer 550, web-hosting portal 560, and call center 570. In one embodiment, land network 544 is a public-switched telephone network (PSTN). In another embodiment, land network 544 is implemented as an Internet protocol (IP) network. In other embodiments, land network 544 is implemented as a wired network, an optical network, a fiber network, other wireless networks, or any combination thereof. Land network 544 is connected to one or more landline telephones. Communication network 542 and land network 544 connect wireless carrier system 540 to web-hosting portal 560, and call center 570.

Client, personal, or user computer 550 includes a computer usable medium to execute Internet browser and Internet-access computer programs for sending and receiving data over land network 544 and, optionally, wired or wireless communication networks 542 to web-hosting portal 560. Computer 550 sends user preferences to web-hosting portal 560 through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 510. In operation, a client utilizes computer 550 to initiate setting or re-setting of user preferences for MVCU 510. User-preference data from client-side software is transmitted to server-side software of web-hosting portal 560. User-preference data is stored at web-hosting portal 560.

Web-hosting portal 560 includes one or more data modems 562, one or more web servers 564, one or more databases 566, and a network system 568. Web-hosting portal 560 is connected directly by wire to call center 570, or connected by phone lines to land network 544, which is connected to call center 570. In an example, web-hosting portal 560 is connected to call center 570 utilizing an IP network. In this example, both components, web-hosting portal 560 and call center 570, are connected to land network 544 utilizing the IP network. In another example, web-hosting portal 560 is connected to land network 544 by one or more data modems 562. Land network 544 sends digital data to and receives digital data from modem 562, data that is then transferred to web server 564. Modem 562 can reside inside web server 564. Land network 544 transmits data communications between web-hosting portal 560 and call center 570.

Web server 564 receives user-preference data from user computer 550 via land network 544. In alternative embodiments, computer 550 includes a wireless modem to send data to web-hosting portal 560 through a wireless communication network 542 and a land network 544. Data is received by land network 544 and sent to one or more web servers 564. In one embodiment, web server 564 is implemented as any suitable hardware and software capable of providing web services to help change and transmit personal preference settings from a client at computer 550 to telematics unit 520. Web server 564 sends data transmissions to or receives data transmissions from one or more databases 566 via network system 568. Web server 564 includes computer applications and files for managing and storing personalization settings supplied by the client, such as door lock/unlock behavior, radio station preset selections, climate controls, custom button configurations, and theft alarm settings. For each client, the web server potentially stores hundreds of preferences for wireless vehicle communication, networking, maintenance, and diagnostic services for a mobile vehicle.

In one embodiment, one or more web servers 564 are networked via network system 568 to distribute user-preference data among its network components such as database 566. In an example, database 566 is a part of or a separate computer from web server 564. Web server 564 sends data transmissions with user preferences to call center 570 through land network 544.

Call center 570 is a location where many calls are received and serviced at the same time, or where many calls are sent at the same time. In one embodiment, the call center is a telematics call center, facilitating communications to and from telematics unit 520. In an example, the call center is a voice call center, providing verbal communications between an advisor in the call center and a subscriber in a mobile vehicle. In another example, the call center contains each of these functions. In other embodiments, call center 570 and web-hosting portal 560 are located in the same or different facilities.

Call center 570 contains one or more voice and data switches 572, one or more communication services managers 574, one or more communication services databases 576, one or more communication services advisors 578, and one or more network systems 580.

Switch 572 of call center 570 connects to land network 544. Switch 572 transmits voice or data transmissions from call center 570 and receives voice or data transmissions from telematics unit 520 through wireless carrier system 540, communication network 542, and land network 544. Switch 572 receives data transmissions from and sends data transmissions to one or more web-hosting portals 560. Switch 572 receives data transmissions from or sends data transmissions to one or more communication services managers 574 via one or more network systems 580.

Communication services manager 574 is any suitable hardware and software capable of providing requested communication services to telematics unit 520. Communication services manager 574 sends data transmissions to or receives data transmissions from one or more communication services databases 576 via network system 580. Communication services manager 574 sends data transmissions to or receives data transmissions from one or more communication services advisors 578 via network system 580. Communication services database 576 sends data transmissions to or receives data transmissions from communication services advisor 578 via network system 580. Communication services advisor 578 receives from or sends to switch 572 voice or data transmissions.

Communication services manager 574 provides one or more of a variety of services, including enrollment services, navigation assistance, directory assistance, roadside assistance, business or residential assistance, information services assistance, emergency assistance, and communications assistance. Communication services manager 574 receives service-preference requests for a variety of services from the client via computer 550, web-hosting portal 560, and land network 544. Communication services manager 574 transmits user-preference and other data to telematics unit 520 through wireless carrier system 540, communication network 542, land network 544, voice and data switch 572, and network system 580. Communication services manager 574 stores or retrieves data and information from communication services database 576. Communication services manager 574 can provide requested information to communication services advisor 578.

In one embodiment, communication services advisor 578 is implemented as a real advisor. In an example, a real advisor is a human being in verbal communication with a user or subscriber (e.g., a client) in MVCU 510 via telematics unit 520. In another embodiment, communication services advisor 578 is implemented as a virtual advisor. In an example, a virtual advisor is implemented as a synthesized voice interface responding to requests from telematics unit 520 in MVCU 510.

Communication services advisor 578 provides services to telematics unit 520. Services provided by communication services advisor 578 include enrollment services, navigation assistance, real-time traffic advisories, directory assistance, roadside assistance, business or residential assistance, information services assistance, emergency assistance, and communications assistance. Communication services advisor 578 communicates with telematics unit 520 through wireless carrier system 540, communication network 542, land network 544, and web-hosting portals 560 using voice transmissions. In an alternative embodiment, communication services manager 574 communicates with telematics unit 520 through wireless carrier system 540, communication network 542, land network 544, and web hosting portals 560 using voice transmissions. Switch 572 selects between voice transmissions and data transmissions.

In one embodiment, call center 570 obtains location information from telematics unit 520. In response to obtaining the location information, call center 570 compares the location information to locations that have historically resulted in reduced accuracy of location estimation, and call center 570 provides instructions to change sensor determinations. Call center 570, in such an embodiment, maintains a history similar to history 118 described in FIG. 1, and provides results of this history to vehicles based on their location.

For example, using GPS unit 526, a vehicle enters the urban canyon in Detroit, Mich., surrounding the Renaissance Center and the location reported by GPS unit 526 is reported to call center 570. A history maintained by call center 570 indicates that vehicles entering this urban canyon have historically had a poor DOP value. In response, using a wireless network, call center 570 instructs the sensor discriminator 100 that a high quality indicator was previously achieved by combining the odometer pulses (110 in FIG. 1), gyroscope (106 in FIG. 1) and differential wheel speed sensor (114 in FIG. 1), and switches the GPS unit 526 sensor out of the calculation of vehicle location while switching the differential wheel speed sensor (114 in FIG. 1) into the calculation.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for determining a vehicle location, the method comprising:
receiving location inputs from at least one location indicators;
determining a quality indicator for each of the location indicators; and
selecting at least one location indicators responsive to said quality indicators; and
determining the vehicle location based on the selected location indicators.

2. The method of claim 1 further comprising storing a location alert corresponding to a failed quality indicator.

3. The method of claim 2 further comprising determining the vehicle location based on the stored location alert.

4. The method of claim 1 wherein the location inputs are received in a telematics unit.

5. The method of claim 1 wherein determining the vehicle location comprises filtering the sensor data.

6. The method of claim 5 wherein filtering the sensor data comprises filtering the sensor data using a Kalman filter.

7. A computer readable medium storing a computer program for assisting in locating a vehicle, the medium including computer readable code comprising:
computer readable code for receiving location inputs from at least one location indicators;
computer readable code for determining a quality indicator for each location indicator;
computer readable code for selecting at least one location indicators responsive to said quality indicators; and
computer readable code for determining the vehicle location based on the selected location indicators.

8. The medium of claim 7 further comprising computer readable code for storing a location alert corresponding to a failed quality indicator.

9. The medium of claim 7 further computer readable code for determining the vehicle location based on the stored location alert.

10. The medium of claim 7 wherein the location inputs are received in a telematics unit.

11. The medium of claim 7 wherein computer readable code for determining the vehicle location comprises computer readable code for filtering the sensor data.

12. The medium of claim 11 wherein the computer readable code for filtering the sensor data comprises a Kalman filter.

13. A system for assisting in locating a vehicle, the system comprising:
means for receiving location inputs from at least one location indicators;
means for determining a quality indicator for each location indicator;
means for selecting at least one location indicators responsive to said quality indicators; and
means for determining the vehicle location based on the selected location indicators at last one

14. (canceled)

15. (canceled)

16. (canceled)

17. (canceled)

18. (canceled)

19. The method of claim 1 wherein the location indicator is at least one of vehicle speed, electronic compass headings, and differential wheel speed.

20. The method of claim 1 further comprising:
storing a location alert corresponding to the failed quality indicator; and
sending the stored location alert to a call center using a wireless network.

21. The method of claim 1 further comprising:
receiving a location alert from a call center via a wireless network; and
wherein selecting at least one location input is based on the received location alert.

22. The method of claim 1 wherein determining a quality indicator comprises receiving a dilution of precision signal; and
comparing the dilution of precision signal to a threshold value.

23. The method of claim 1 wherein determining the location sensors comprises querying a vehicle bus.

24. The method of claim 2 wherein the location alert includes information selected from the group consisting of time of day, vehicle location vehicle speed, vehicle acceleration, and differential wheel speed.

25. The method of claim 1 wherein determining the vehicle location based on the quality indicators comprises switching a GPS unit sensor out of the determination of vehicle location.
